(19) United States
(12) Patent Application Publication
(10) Pub. No.: US 2007/0215421 A1
(43) Pub. Date: Sep. 20, 2007

(54) Magnetorheological Rotary Damper

(75) Inventor: Eric N. Anderfaas, Westminster, CA (US)

Correspondence Address: Jeffrey A. Pyle;WILLIAMS, MORGAN & AMERSON, P.C., Suite 1100, 10333 Richmond Drive, Houston, TX, 77042, US

(73) Assignee: Lockheed Martin Corporation

(21) Appl. No.: 11/749,547

(22) Filed: May 16, 2007

Related U.S. Application Data
(63) Continuation-in-part of application No. 10/371,785, filed on Feb. 21, 2003, now abandoned.

(51) Int. Cl. F16F 9/53

(52) U.S. Cl. 188/267.2

(57) ABSTRACT

A rotary damper is disclosed. The rotary damper comprises a first and a second plurality of plates disposed within a housing. The first and second pluralities of plates are interleaved and are capable of moving relative to one another. A magnetorheological fluid contained within the housing resides in the interleave of the first and second plurality of plates. A magnetic flux generator drives a magnetic flux through the magnetorheological fluid in the interleave in a direction transverse to the orientation of the plates and is capable of varying the strength of the driven magnetic flux. The magnetic flux aligns the magnetic particles suspended in the magnetorheological fluid, increasing the shear strength of the magnetorheological fluid, which in turn resists motion between the first and second plurality of plates, acting as a damper.

### BACKGROUND OF THE INVENTION

1. Field of the Invention

The present invention pertains to a damper, and, more particularly, a magnetorheological (“MR”) rotary damper.

2. Description of the Related Art

Numerous types of machines employ rotors, or parts that rotate, for a variety of reasons. Frequently, the designer incorporates a mechanism to help control the movement of the rotor. One mechanism used for this purpose is a “rotary damper”, so-called because it controls motion with regards to angular velocity in a rotary or circular movement.

A wide variety of rotary dampers are well known to the art. However, as with all technologies, each type of rotary damper has drawbacks as well as advantages. One common problem is achieving a sufficiently rapid response in damping the rotor's movement for certain types of applications. For many applications, rapid response is not an issue. But, for certain high performance applications, it becomes critical. As the range of applications broadens because of advance in technology, the number of these high performance applications concomitantly increases.

Consider, for instance, a wheeled vehicle. Some wheeled vehicles include suspension systems employing rotary dampers. A rapid response from the rotary dampers is important in order to provide a smooth, comfortable ride for a passenger. But, there are many other reasons, such as safety, e.g., to help a driver keep control of the vehicle.

However, as a variety of technologies have improved, robotic vehicles have become more ubiquitous. Robotic vehicles typically rely on numerous sensors to collect data from which the operation of the vehicle is controlled. Poor response from the rotary dampers can lead to operating conditions in which the sensors collect wrong or inaccurate data. For instance, if a robotic vehicle hits a large obstacle in its path, the sensors might acquire data in a direction different from that in which the vehicle is moving. This could lead to even poorer operating conditions as the robotic controller makes decisions on data that does not accurately reflect the terrain over which the vehicle is actually moving.

Note that this particular consequence is more acute in a robotic vehicle than in a manually operated vehicle. The operator driving a manned vehicle acquires data independently of the operation of the vehicle as a whole through their natural senses, which is untrue of the robotic controller. Granted, a manned operator's data acquisition may be interrupted by a sufficiently violent perturbation, but the risk is much less than it is for the robotic controller. Thus, the rapid response arguably becomes more critical for the robotic vehicle application and rotary dampers with higher bandwidth may be required as compared to dampers for manned vehicles.

The present invention is directed to resolving, or at least reducing, one or all of the problems mentioned above.

### SUMMARY OF THE INVENTION

The invention is a rotary damper comprising a first and a second plurality of plates disposed within a housing. The first and second pluralities of plates are interleaved and are capable of moving relative to one another. A magnetorheological fluid contained within the housing resides in the interleave of the first and second plurality of plates. A magnetic flux generator drives a magnetic flux through the magnetorheological fluid in the interleave in a direction transverse to the orientation of the plates and is capable of varying the strength of the driven magnetic flux.

### BRIEF DESCRIPTION OF THE DRAWINGS

The invention may be understood by reference to the following description taken in conjunction with the accompanying drawings, in which like reference numerals identify like elements, and in which:

FIG. 1 is a perspective view of one particular embodiment of a rotary damper constructed in accordance with the present invention;

FIG. 2 is a perspective, section view of the rotary damper of FIG. 1;

FIG. 3 provides a partial, perspective, section view of the rotary damper of FIG. 1;

FIG. 4A and FIG. 4B enlarge and detail a portion of the section view of FIG. 2 in plan and perspective views, respectively;

FIG. 5A enlarges and details a portion of the section view in FIG. 2 alternative to that shown in FIG. 4A in a plan view;

FIG. 5B illustrates a means for maintaining a predetermined level of the magnetorheological fluid within the housing;

FIG. 6 illustrates one segment of the segmented flux housing in the embodiment of FIG. 1 and FIG. 2;

FIG. 7 depicts a robotic vehicle in which the rotary damper of FIG. 1-FIG. 6 may be employed in one particular implementation; and

FIG. 8 and FIG. 9 depict, in block diagrams, two alternative control systems that may be used in conjunction with the invention in the robotic vehicle of FIG. 7.

While the invention is susceptible to various modifications and alternative forms, the drawings illustrate specific embodiments herein described in detail by way of example. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort, even if complex and time-consuming, would be a routine undertaking for those of ordinary skill in the art having the benefit of this disclosure.

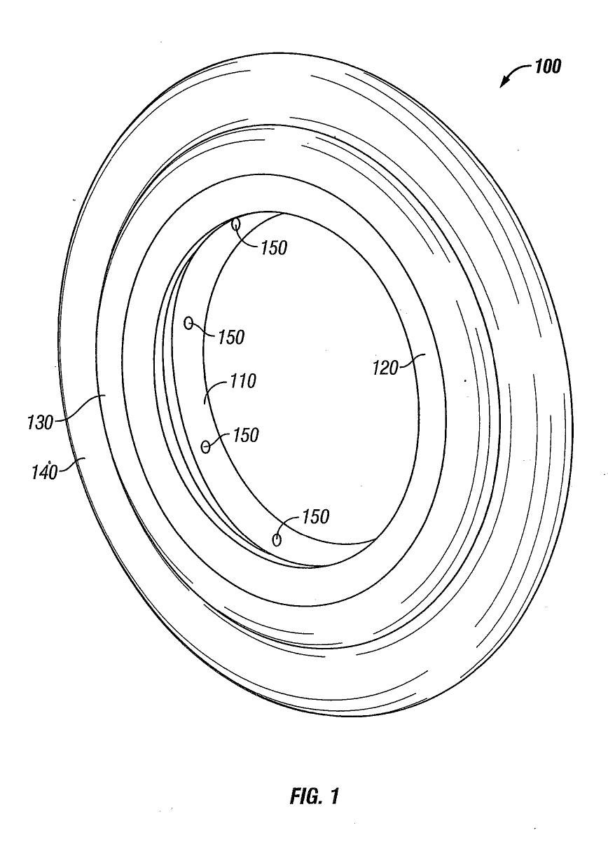

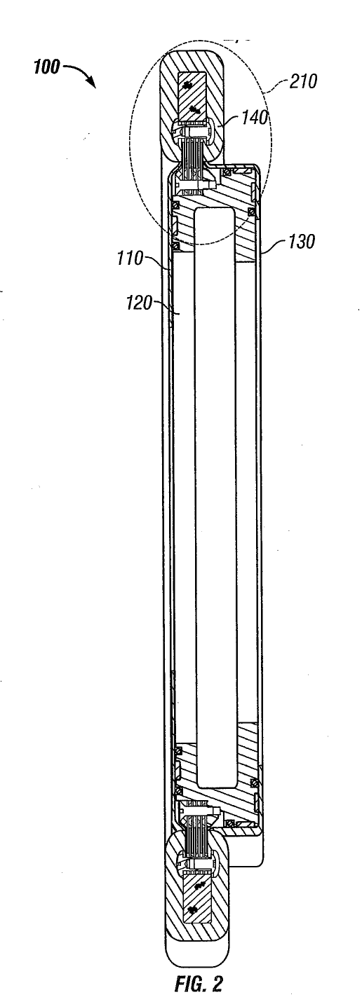

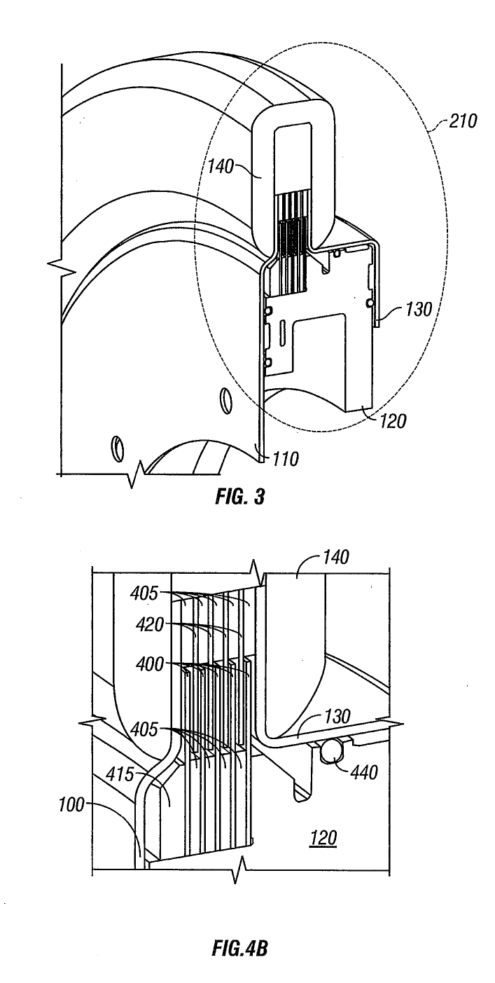

Turning now to the drawings, FIG. 1, FIG. 2, and FIG. 3 illustrate one particular embodiment of a rotary damper 100 constructed in accordance with the present invention. The rotary damper 100 includes an inner housing 110, a rotor 120, an outer housing 130, and a segmented flux housing 140. The inner housing 110 and outer housing 130 are fabricated from a “soft magnetic” material (a material with magnetic permeability much larger than that of free space), e.g., mild steel. The rotor 120 is made from a “nonmagnetic” material (a material with magnetic permeability close to that of free space), e.g., aluminum. In one embodiment, the segmented flux housing 140 is fabricated from a high performance magnetic core laminating material commercially available under the trademark HIPERCO 50® from:
Carpenter Technology Corporation
P.O. Box 14662
Reading, Pa. 19612-4662
U.S.A.
Phone: (610) 208-2000
FAX: (610) 208-3716
   However, other suitable, commercially available soft magnetic materials, such as mild steel, may be used.

The rotary damper 100 is affixed to, in this particular embodiment, a vehicle chassis (not shown) by fasteners (also not shown) through a plurality of mounting holes 150 of the inner housing 110. The rotor 120 is made to rotate with the pivoting element (not shown) with the use of splines or drive dogs (also not shown). Note that the rotary damper 100 may be affixed to the pivot and the chassis in any suitable manner known to the art. The rotary damper 100 damps the rotary movement of the pivot relative to the vehicle chassis in a manner more fully explained below.

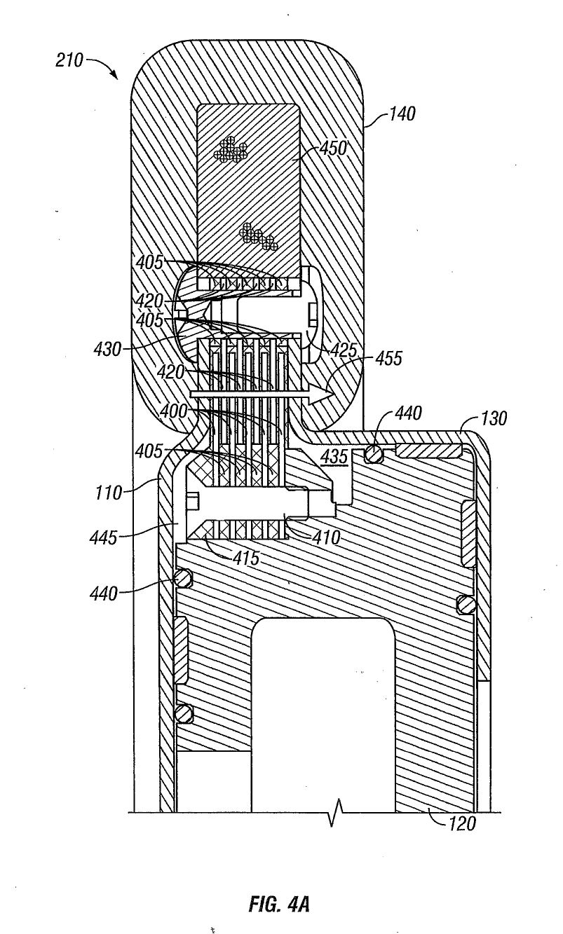

A portion 210 of the rotary damper 100 in the view of FIG. 2 is enlarged and detailed in FIG. 4A and FIG. 4B. Pluralities of rotor plates 400, separated by magnetic insulators 405, are affixed to the rotor 120 by, in this particular embodiment, a fastener 410 screwed into the rotor plate support 415 of the rotor 120. A plurality of housing plates 420, also separated by magnetic insulators 405, are affixed to an assembly of the inner housing 110 and outer housing 130, in this embodiment, by a fastener 425 in a barrel nut 430. Note that the assembled rotor plates 400 and the assembled housing plates 420 are interleaved with each other. The number of rotor plates 400 and housing plates 420 is not material to the practice of the invention.

The rotor plates 400 and the housing plates 420 are fabricated from a soft magnetic material having a high magnetic permeability, e.g., mild steel. The magnetic insulators 405, the fasteners 410, 425, and the barrel nut 430 are fabricated from nonmagnetic materials, e.g., aluminum or annealed austenitic stainless steel. The nonmagnetic fasteners can be either threaded or permanent, e.g. solid rivets. The rotor plates 400 and the housing plates 420 are, in this particular embodiment, disc-shaped. However, other geometries may be used in alternative embodiments and the invention does not require that the rotor plates 400 and the housing plates 420 have the same geometry.

Still referring to FIG. 4A, the assembled inner housing 110, rotor 120, and outer housing 130, define a chamber 435. A plurality of o-rings 440 provide a fluid seal for the chamber 435 against the rotation of the rotor 120 relative to the assembled inner housing 110 and outer housing 130. An MR fluid 445 is contained in the chamber 435 and resides in the interleave of the rotor plates 400 and the housing plates 420 previously described above. In one particular embodiment, the MR fluid 445 is MRF132AD, commercially available from:
Lord Corporation
Materials Division
406 Gregson Drive
P.O. Box 8012
Cary, N.C. 27512-8012
U.S.A
Ph: 919/469-2500
FAX: 919/481-0349
   However, other commercially available MR fluids may also be used.

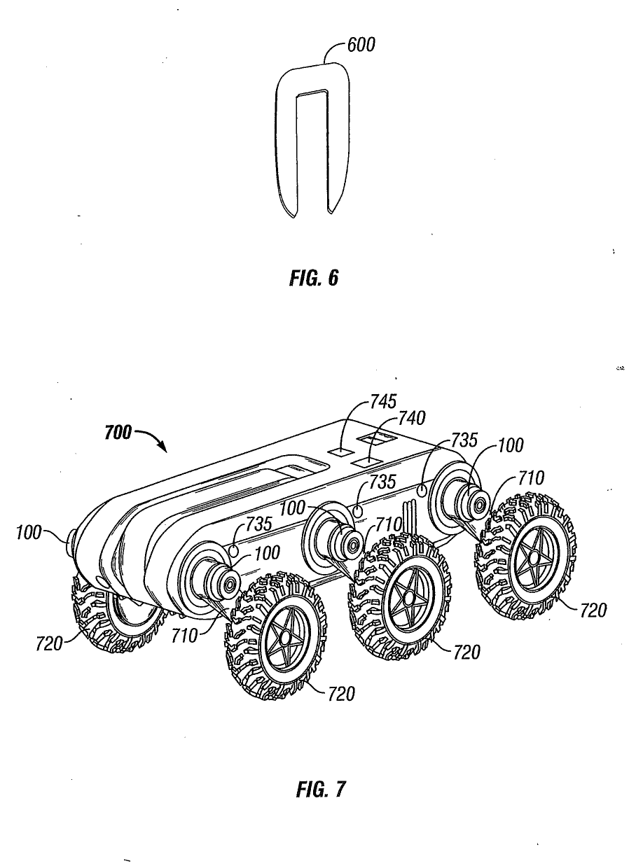

FIG. 6 illustrates one segment 600 of the segmented housing 140 in the illustrated embodiment. A number of segments such as the segment 600 are assembled together to fabricate the magnetic flux housing 140. The segments 600 are fabricated from a soft magnetic material, e.g., mild steel or Hiperco 50®, using any suitable technology. High performance soft magnetic materials (which saturate at magnetic flux densities greater than 1.5 Tesla) can yield a flux housing 140 of reduced mass. Suitable assembly techniques may include, but are not limited to, fastening (e.g., by screws, bolts, or bands), adhering (e.g. by glue or epoxy), and metallurgy (e.g., welding or brazing). The precise number segments 600 will be implementation specific depending on, e.g., the thickness of the segments 600 and the diameter of the rotary damper 100. The segmented construction was selected for a number of reasons. For instance, the materials desired for the illustrated embodiment is only commercially available in thin strips. From a performance standpoint, the segmented construction should improve the transient behavior of the rotary damper 100 by reducing the effects of eddy current component core losses, which should be a substantial concern for high performance applications.

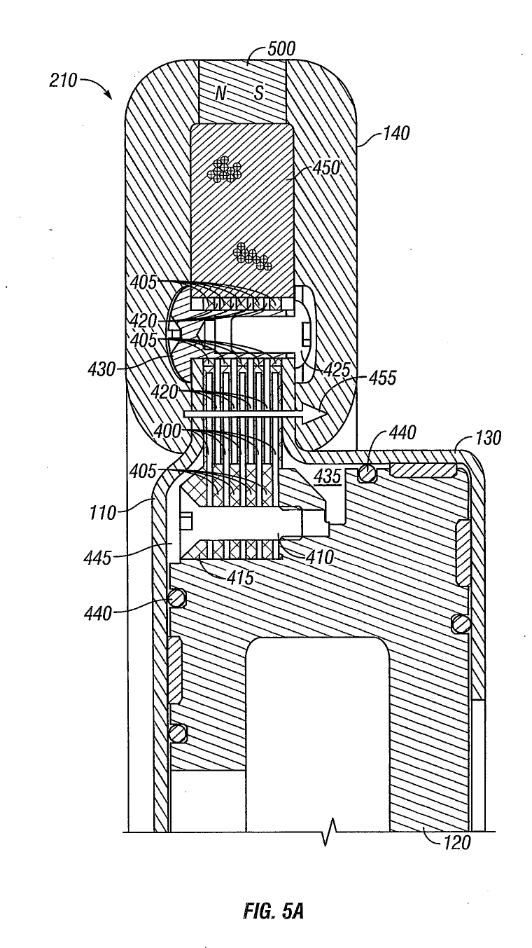

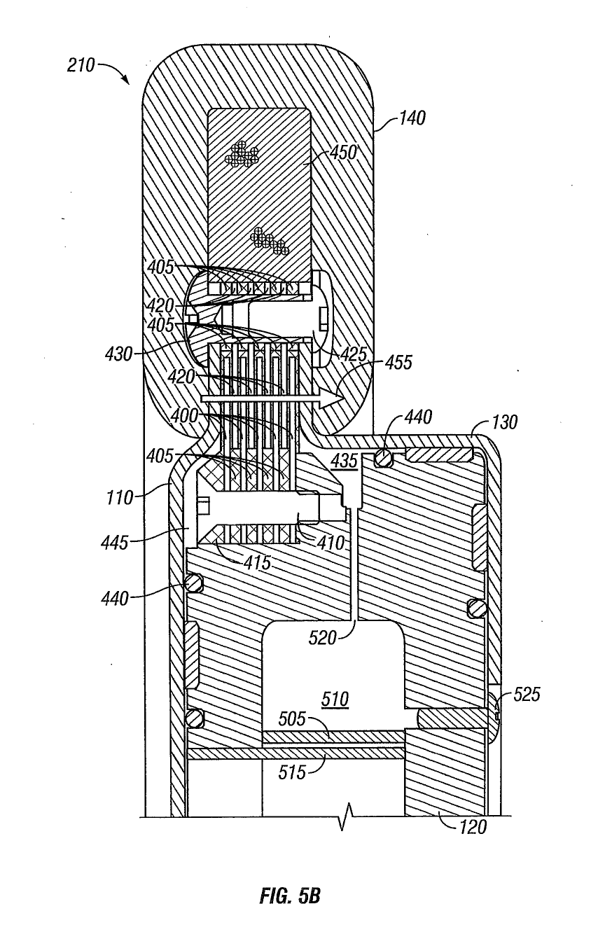

The segmented flux housing 140 contains a coil 450, the segmented flux housing 140 and coil 450 together comprising an electromagnet. The coil 450, when powered, generates a magnetic flux in a direction transverse to the orientation of the rotor plates 400 and the housing plates 420, as represented by the arrow 455. Alternatively, as shown in FIG. 5A, a permanent magnetic 500 could be incorporated into the flux housing 140 to bias the magnetic flux 455. The coil 450 drives the magnetic flux through the MR fluid 445 and across the faces of the rotor plates 400 and the housing plates 420. The sign of the magnetic flux is not material to the practice of the invention.

The magnetic flux aligns the magnetic particles suspended in the MR fluid 445 in the direction of the magnetic flux. This magnetic alignment of the fluid particles increases the shear strength of the MR fluid 445, which resists motion between the rotor plates 400 and the housing plates 420. When the magnetic flux is removed, the suspended magnetic particles return to their unaligned orientation, thereby decreasing or removing the concomitant force retarding the movement of the rotor plates 400.

Note that it will generally be desirable to ensure a full supply of the MR fluid 445. Some embodiments may therefore include some mechanism for accomplishing this. For instance, some embodiments may include a small fluid reservoir to hold an extra supply of the MR fluid 445 to compensate for leakage and a compressible medium for expansion of the MR fluid 445. The compressible medium might include, for example, a gas charged accumulator—a flexible diaphragm with compressed gas on one side and a small reservoir of MR fluid 445 on the other. Nitrogen would be one suitable gas for this purpose. Such a device would also ensure a full supply of the MR fluid 445 over a wider temperature range. However, this is not necessary to the practice of the invention.

However, one such device is shown in FIG. 5B. In this particular embodiment, a soft, closed-cell foam 505 is employed as the compressible medium. The reservoir chamber 510 is created inside the rotor 120, which has been sealed off by a tube 515 that is bonded and sealed into the rotor 120. A channel 520 is fabricated between the reservoir chamber 510 and the active MR fluid chamber 435 by drilling holes through the rotor 120 or some other suitable technique. A drain plug 525 plug 525 has been added so that the MR fluid 445 can be added or removed from the MR rotary damper 100.

In operation, the illustrated embodiment employs a control system (not shown) to sense the relative movement between the rotary plates 400 and the housing plates 420 and other variables relating to the system using a plurality of sensors (not shown). Note that this, too, is not necessary to the practice of the invention. Some embodiments may, for instance, infer the relative movement from some other sensed quantity. One exemplary sensed quantity would be the speed of a vehicle of which the rotary damper 100 is a part.

Returning to the illustrated embodiment, the control system commands an electrical current to be supplied to the coil 450. This electric current then creates a magnetic flux 455 and the rotary damper 100 resists relative motion between the housings 110, 130 and the rotor 120. Depending on the geometry of the rotary damper 100 and the materials of its construction, there is a relationship between the electric current, the relative angular velocity between the housings 110, 130 and the rotor 120, and the resistive torque created by the rotary damper 100. In general this resistive torque created by the rotary damper 100 increases with the relative angular motion between the housings 110, 130 and the rotor 120 and larger magnetic flux density through the fluid as generated by the coil electric current.

Note that, in addition to the relative angular rate and the magnitude of the magnetic flux, other factors influence the performance of the rotary damper 100. The resistive torque is also related to the total surface area of the MR fluid 445 being sheared, the radius of this area from the pivot center, the thickness of the sheared fluid, and the properties of the MR fluid 445 used. This fluid shear area is related to the number of rotor plates 400, housing plates 420 and the overlapping area between these plates. The fluid thickness is equal to the gap between each of these plates in the device assembly. In general, the larger the fluid shear area, the larger the average radius of this area, and the smaller the fluid thickness, the higher the rotary damper resistive torque in the device. This applies to the full range of tenderization of the device, from the “maximum on-state”, the un-energized “off-state” and for any other energized states between these extremes.

As is known in the art, the properties of an MR fluid can be greatly influenced depending on the base fluid, the type and particle size distribution of the magnetic particles and the magnetic particle loading of the fluid, among others. For example, a fluid with a higher magnetic particle loading will improve both the maximum fluid yield shear stress as well as the magnetic permeability of the fluid, although there is a corresponding increases in fluid “off-state” viscous drag (typically an MR fluid is a non-Newtonian fluid and the apparent fluid viscosity is related to the shear rate applied on the fluid with higher shear rates resulting in lower apparent fluid viscosity). This change in fluid properties would result in an MR rotary damper 100 with higher controllable resistive torque capability at slightly less commanded coil electric currents, although when turned off, the device would also have higher resistive torque.

The magnetic and corresponding electrical properties of the device are strongly dependent on the fluid and the device geometry. These design elements define the magnetic energy storage of the device when energized, which in turn relates to the device inductance depending of the number of wire turns in the electrical coil. A large electrical inductance (L) may reduce the speed of response or bandwidth, of the rotary damper, since this inductance relates the rate of change in coil current (i) with respect to time (t) to the voltage (e) applied to the coil (di/dt=e/L for a device with constant inductance). For a typical MR damper the inductance tends to have the largest value at low currents and magnetic saturation effects reduce the apparent inductance at larger device currents.

Unfortunately, the MR rotary damper tends to have a high inductance. This problem can be mitigated with the use of high control voltages which allow for high rates of change in damper current (di/dt), although this may lead to increased power demands and higher levels of inefficiency depending on the design and the software control driving the rotary damper 100. Another technique, which may improve the bandwidth and efficiency of the MR rotary damper, uses multiple coil windings. One such system could use two coil windings; one high inductance, slow coil with a high number of turns of small diameter wire and a second low inductance, fast coil with a low number of turns of larger diameter wire. The slow coil would be used to bias the rotary damper 100 while the fast coil could be used to control around this bias. However, the two coil windings may be highly coupled due to the mutual inductance between them in some implementations, which would be undesirable.

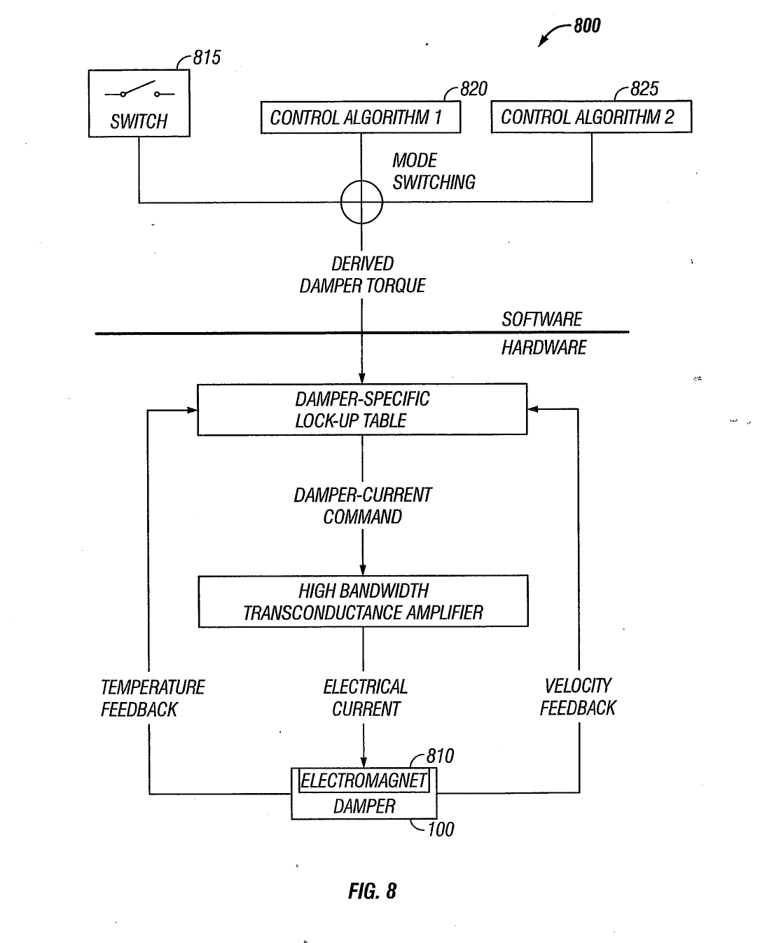

The present invention admits wide variation and enjoys a wide range of applications. FIG. 7 illustrates one such application, i.e., as part of the suspension system for a robotic vehicle 700. The robotic vehicle 700 is designed to be airdropped into an operational theater and then traverse the local terrain, which may be quite rugged. The robotic vehicle 700 employs six rotary dampers 100 to control the rotation of the arms 710 to which the wheels 720 are mounted relative to the chassis 730. Thus, the arms 710 and the chassis 730 constitute the pivot to which the rotary damper 100 is affixed and the vehicle chassis, respectively, discussed above.

The robotic vehicle 700 employs an arm positions sensor 735 (only three shown) for each arm 710. The arm position sensors 735 measure the relative position of the respective arms 710 to the vehicle chassis 730. From this measurement the relative angular velocity of the arms 710 could also be determined. As a simple damper, the MR rotary damper 100 would be commanded (e.g., a control system 740) to produce a torque proportional to and against the arm angular velocity. More advanced control algorithms could command the MR rotary damper 100 to produce a resistive torque related to other variables such as: the positions of the arms 710 relative to the chassis 730, the vertical acceleration on the vehicle chassis 730, the vehicle roll and pitch angles and angular rates, and the wheel hub motor torques (these would be determined by the vehicle control for controlling vehicle speed and turning). The illustrated embodiments also employs an inertial sensor 745 to help measure some of these variables.

The versatility of the present invention is particularly evident from this implementation. The robotic vehicle 700 operates under software control, in this particular embodiment, in eight modes: air drop, high speed suspension, arm articulation, sensor stabilization, low power, optimized traction, drive reaction torque opposition, and off. The software control optimizes the suspension system, through the rotary dampers 100, by controlling the current supplied in the coil, which creates a resistive torque applied to the suspension arm in some form of optimal way. The rotary dampers 100 are employed in a semi-active suspension system, although alternative embodiments may employ the rotary dampers 100 in an active suspension system.

TABLE 1
Operational Modes of MR Rotary Damper
and Operational Optimizations

| | Optimized for: | | | Performance |
|---|---|---|---|---|
| Mode | Torque | Response | Power | Description |
| Air Drop | X | | | Rotary dampers dissipate |
| | | | | kinetic energy of falling |
| | | | | vehicle-very high |
| | | | | resultant torques at the |
| | | | | rotary damper. |
| High Speed | X | X | | Rotary dampers quickly |
| Suspension | | | | increase damping force to |
| | | | | absorb impact from |
| | | | | encountering a large |
| | | | | obstacle. |
| Arm | X | X | X | Rotary dampers |
| Articulation | | | | efficiently facilitate rapid |
| | | | | changes in holding torque |
| | | | | to stabilize the vehicle |
| | | | | sprung mass. |
| Sensor | | X | | Rotary dampers support |
| Stabilization | | | | higher bandwidth than |
| | | | | wheel frequency for |
| | | | | preferred sensor isolation. |
| Low Power | | | X | Rotary dampers |
| | | | | optimized for efficiency |
| | | | | over primary or |
| | | | | secondary roads. |
| Optimized | | X | | Rotary dampers support |
| Traction | | | | higher bandwidth than |
| | | | | wheel frequency for tire |
| | | | | traction optimization. |
| Drive | | X | X | Rotary dampers quickly |
| Reaction | | | | yet efficiently adapt to |
| torque | | | | changing drive torques to |
| opposition | | | | reduce coupling between |
| | | | | drive torque and |
| | | | | suspension motion. |
| Off | | | | Rotary dampers have a |
| | | | | low off-state torque. |

Of the eight modes, the air drop mode should require the highest reaction torque by the rotary dampers 100, while the high speed suspension mode should require the fastest response of the damper control system. In the Air Drop mode, the suspension position is set for maximal energy absorption and all of the rotary dampers 100 are turned fully on during the fall so that speed of response is not an issue for this operational mode. The highest peak torque occurs on the middle set of suspension arms 710 just after landing, and requiring a peak torque of 22,000 in lb (2500 N m). The middle arms 710 also have the highest arm velocities with a peak around 1400 deg/sec or 25 radian/sec. One difference between the air drop and high speed suspension modes is that, in the high speed suspension mode, the robotic vehicle 700 does not necessarily have knowledge about upcoming bumps and other disturbances. The suspension system therefore should have adequate bandwidth and reaction torque capability for the rotary damper 100 to absorb these impacts with minimal effect on is the robotic vehicle 700. Generally, in encountering an obstacle, the front suspension arm 710 has the highest reaction torque, 7500 in lb (850 N m), and also the highest arm velocities, 500 deg/sec or 9 radian/sec.

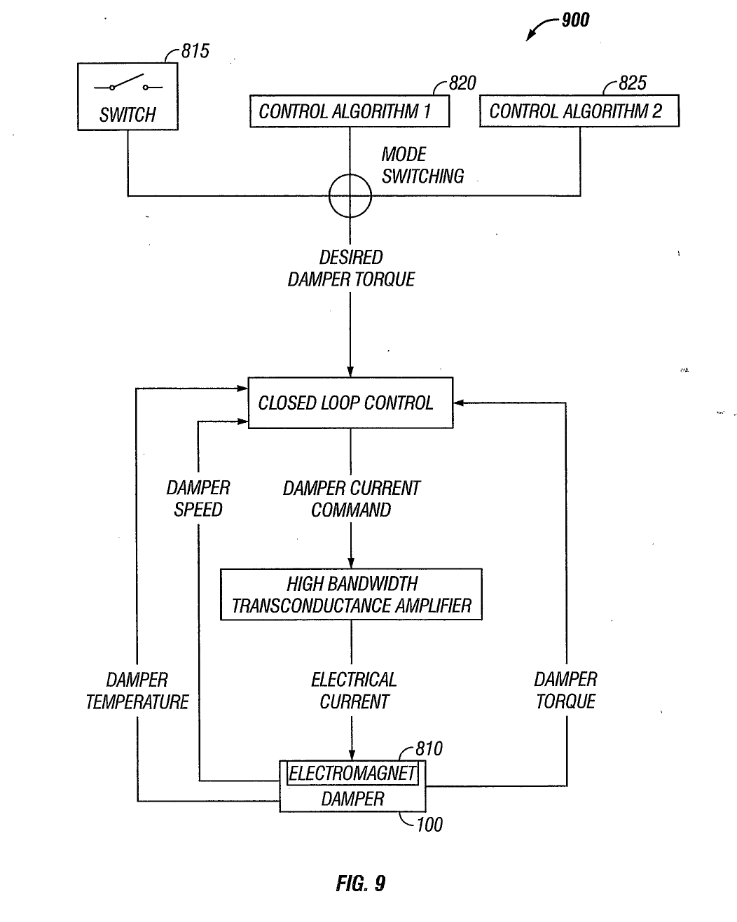

FIG. 8 and FIG. 9 depict, in block diagrams, two alternative control systems 800 and 900, respectively, that may be used in conjunction with the invention in the robotic vehicle 700 of FIG. 7. Each of the control systems 800, 900, controls one or more rotary dampers 100. In the illustrated embodiment, each rotary damper 100 is accompanied by an electromagnet 810 used to generate a magnetic flux from the coil 450 (shown first in FIG. 4A) of the rotary damper 100.

In both the control systems 800, 900, a control mechanism (not shown) makes some determination, directly or indirectly, of how much torque is to be applied by the rotary damper 100 onto the suspension. For instance, the robotic vehicle 700 in FIG. 7 could be remotely controlled by a person or under the autonomous control of an on-board processor. The decision of this control mechanism can be communicated by, e.g., a switch 815, a control algorithm 820, 825, or some combination of these. For instance, a processor (not shown) on the vehicle 700, responsive to sensor inputs, could decide that the vehicle 700 should operate in one of the modes discussed above and presented in Table 1. This decision could be communicated through the control algorithm 820, for instance. However, any suitable technique known to the art may be used to perform this aspect of the illustrated embodiment.

This concludes the detailed description. The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A rotary damper, comprising:
a housing;
a first plurality of plates disposed within the housing;
a second plurality of plates disposed within the housing and interleaved with the first plurality of plates, the second plurality of plates capable of moving relative to the first plurality of plates;
a magnetorheological fluid contained within the housing and residing in the interleave of the first and second plurality of plates; and
a magnetic flux generator capable of driving a magnetic flux through the magnetorheological fluid in the interleave in a direction transverse to the orientation of the plates and capable of varying the strength of the driven magnetic flux.

2. The rotary damper of claim 1, further comprising a plurality of sensors for sensing the magnitude of the relative movement between the first and second plurality of plates.

3. The rotary damper of claim 1, wherein at least one of the first plurality of plates and the second plurality of plates comprises a plurality of discs.

4. The rotary damper of claim 1, wherein the magnetic flux generator is disposed within the housing.

5. The rotary damper of claim 1, wherein the housing includes:
an inner housing; and
an outer housing.

6. The rotary damper of claim 1, wherein the magnetic flux generator includes:
a flux housing; and
at least one of a powered coil and an electromagnet.

7. The rotary damper of claim 6, wherein the flux housing is segmented.

8. The rotary damper of claim 1, further comprising means for maintaining a predetermined level of the magnetorheological fluid within the housing.

9. The rotary damper of claim 8, wherein the maintaining means includes:
a reserve supply of the magnetorheological fluid; and
a compressible medium capable of expanding to drive the reserve supply into the housing.

10. The rotary damper of claim 9, wherein the compressible medium is a gas charged accumulator or a soft, closed-cell foam.

11. A rotary damper, comprising:
means for rotating a first body relative to a second body;
a magnetorheological fluid capable of acting on the rotating means to control the angular velocity of the relative rotation;
means for driving a magnetic flux through the magnetorheological fluid to control the angular velocity; and
means for housing the rotating means and for containing the magnetorheological fluid.

12. The rotary damper of claim 11, further comprising a plurality of sensors for sensing the magnitude of the relative movement between the first and second plurality of plates.

13. The rotary damper of claim 11, wherein the rotating means comprises:
a first plurality of plates associated with the first body and disposed within the housing means; and
a second plurality of plates associated with the second body and disposed within the housing means, the second plurality of plates being interleaved with the first plurality of plates and being capable of moving relative to the first plurality of plates.

14. The rotary damper of claim 13, wherein at least one of the first plurality of plates and the second plurality of plates comprises a plurality of discs.

15. The rotary damper of claim 11, wherein the magnetic flux driving means is disposed within the housing.

16. The rotary damper of claim 11, wherein the housing means includes:
an inner housing; and
an outer housing.

17. The rotary damper of claim 11, wherein the magnetic flux driving means includes:
a flux housing; and
at least one of a powered coil and an electromagnet.

18. The rotary damper of claim 17, wherein the flux housing is segmented.

19. The rotary damper of claim 11, further comprising means for maintaining a predetermined level of the magnetorheological fluid within the housing.

20. The rotary damper of claim 19, wherein the maintaining means includes:
a reserve supply of the magnetorheological fluid; and
a compressible medium capable of expanding to drive the reserve supply into the housing.

21. The rotary damper of claim 20, wherein the compressible medium is a gas charged accumulator or a soft, closed-cell foam.

22. A rotary damper, comprising:
a housing;
a plurality of housing plates disposed within the housing;
a plurality of rotor plates disposed within the housing and interleaved with the housing plates, the rotor plates capable of rotary movement relative to the housing plates;
a magnetorheological fluid contained within the housing and residing in the interleave of the housing plates and the rotor plates;
a magnetic flux generator capable of driving a magnetic flux through the magnetorheological fluid in the interleave in a direction transverse to the orientation of the plates and capable of varying the strength of the driven magnetic flux.

23. The rotary damper of claim 22, further comprising a plurality of sensors for sensing the magnitude of the relative movement between the housing and rotor plates.

24. The rotary damper of claim 22, wherein at least one of the housing plates and the rotor plates comprises a plurality of discs.

25. The rotary damper of claim 22, wherein the magnetic flux generator is disposed within the housing.

26. The rotary damper of claim 22, wherein the housing includes:
an inner housing; and
an outer housing.

27. The rotary damper of claim 22, wherein the magnetic flux generator includes:
a flux housing; and
at least one of a powered coil and an electromagnet.

28. The rotary damper of claim 27, wherein the flux housing is segmented.

29. The rotary damper of claim 22, further comprising means for maintaining a predetermined level of the magnetorheological fluid within the housing.

30. The rotary damper of claim 29, wherein the maintaining means includes:
a reserve supply of the magnetorheological fluid; and
a compressible medium capable of expanding to drive the reserve supply into the housing.

31. The rotary damper of claim 30, wherein the compressible medium is a gas charged accumulator or a soft, closed-cell foam.

32. An apparatus, comprising:
a housing;
a first plurality of plates disposed within the housing;
a pivot rotating relative to the housing, including:
a pivot arm; and
a pivot base to which the pivot arm is affixed, the pivot base including a second plurality of plates disposed within the housing and interleaved with the first plurality of plates, the second plurality of plates capable of moving relative to the first plurality of plates;
a magnetorheological fluid contained within the housing and residing in the interleave of the first and second plurality of plates;
a magnetic flux generator capable of driving a magnetic flux through the magnetorheological fluid in the interleave in a direction transverse to the orientation of the plates and capable of varying the strength of the driven magnetic flux.

33. The apparatus of claim 32, further comprising a plurality of sensors for sensing the magnitude of the relative movement between the first and second plurality of plates.

34. The apparatus of claim 32, wherein at least one of the first plurality of plates and the second plurality of plates comprises a plurality of discs.

35. The apparatus of claim 32, wherein the magnetic flux generator is disposed within the housing.

36. The apparatus of claim 32, wherein the housing includes:
an inner housing; and
an outer housing.

37. The apparatus of claim 32, wherein the magnetic flux generator includes:
a flux housing; and
at least one of a powered coil and an electromagnet.

38. The apparatus of claim 37, wherein the flux housing is segmented.

39. The apparatus of claim 32, further comprising means for maintaining a predetermined level of the magnetorheological fluid within the housing.

40. The apparatus of claim 39, wherein the maintaining means includes:
a reserve supply of the magnetorheological fluid; and
a compressible medium capable of expanding to drive the reserve supply into the housing.

41. The apparatus of claim 40, wherein the compressible medium is a gas charged accumulator or a soft, closed-cell foam.

42. An apparatus, comprising:
a pivot; and
a rotary damper, including:
a housing;
a first plurality of plates disposed within the housing;
a second plurality of plates disposed within the housing and interleaved with the first plurality of plates, the second plurality of plates capable of moving relative to the first plurality of plates;
a magnetorheological fluid contained within the housing and residing in the interleave of the first and second plurality of plates; and
a magnetic flux generator capable of driving a magnetic flux through the magnetorheological fluid in the interleave in a direction transverse to the orientation of the plates and capable of varying the strength of the driven magnetic flux.

43. The apparatus of claim 42, further comprising a plurality of sensors for sensing the magnitude of the relative movement between the first and second plurality of plates.

44. The apparatus of claim 42, wherein at least one of the first plurality of plates and the second plurality of plates comprises a plurality of discs.

45. The apparatus of claim 42, wherein the magnetic flux generator is disposed within the housing.

46. The apparatus of claim 42, wherein the housing includes:
an inner housing; and
an outer housing.

47. The apparatus of claim 42, wherein the magnetic flux generator includes:
a flux housing; and
at least one of a powered coil and an electromagnet.

48. The apparatus of claim 47, wherein the flux housing is segmented.

49. The apparatus of claim 42, further comprising means for maintaining a predetermined level of the magnetorheological fluid within the housing.

50. The apparatus of claim 49, wherein the maintaining means includes:
a reserve supply of the magnetorheological fluid; and
a compressible medium capable of expanding to drive the reserve supply into the housing.

51. The apparatus of claim 50, wherein the compressible medium is a gas charged accumulator or a soft, closed-cell foam.

52. A method for damping rotary movement, comprising:
sensing the magnitude of a relative movement between a first plurality of plates interleaved with a second plurality of plates;
driving a magnetic flux through an magnetorheological fluid residing in the interleave of the first and second plurality of plates in a direction transverse to the orientation of the first and second plurality of plates;
and capable of
varying the magnitude of the driven magnetic flux.
